(19) United States
(12) Patent Application Publication
(10) Pub. No.: US 2026/0360620 A1
(43) Pub. Date: Nov. 12, 2026

(54) CAPACITOR

(71) Applicant: Panasonic Intellectual Property Management Co., Ltd., Osaka (JP)

(72) Inventors: FUMIYA KAMBAYASHI, Osaka (JP); TAKASHI SASAKI, Kyoto (JP); SHINJI TAKEOKA, Osaka (JP)

(21) Appl. No.: 19/137,976

(22) PCT Filed: Nov. 27, 2023
(86) PCT No.: PCT/JP2023/042382

§ 371 Date: Jun. 11, 2025

(30) Foreign Application Priority Data
Dec. 21, 2022 (JP) 2022-204821

(51) Int. Cl. H01G 4/10; H01G 4/008; H01G 4/33

(52) U.S. Cl. CPC H01G 4/10; H01G 4/008; H01G 4/33

(57) ABSTRACT

A capacitor includes an anode, a stacked film, and a cathode stacked in this order. The stacked film includes a first insulating layer in contact with the anode, a conductor layer, and a second insulating layer in contact with the cathode stacked in this order. The conductor layer is electrically insulated from both the anode and the cathode.

### TECHNICAL FIELD

The present disclosure relates to a capacitor, and more particularly relates to a capacitor including two electrodes and an insulator between the two electrodes.

### BACKGROUND ART

NPL 1 discloses a stacked structure including two electrodes and a stacked film in which a layer made of HfO₂ and a layer made of ZnO are alternately stacked between the two electrodes.

### CITATION LIST

### Non-Patent Literature

NPL 1: Qiannan Zhang et al. “Semiconducting ZnO effect on Maxwell-Wagner relaxation in HfO₂/ZnO nanolaminates fabricated by atomic layer deposition”, Journal of Physics D: Applied Physics. 47 505302 (2014)

### SUMMARY OF THE INVENTION

A capacitor according to an aspect of the present disclosure includes an anode, a stacked film, and a cathode stacked in this order. The stacked film includes a first insulating layer in contact with the anode, a conductor layer, and a second insulating layer in contact with the cathode, and these layers are stacked in this order. The conductor layer is electrically insulated from both the anode and the cathode.

The present disclosure can provide a capacitor capable of suppressing a change in capacitance associated with a frequency change while increasing the capacitance.

### BRIEF DESCRIPTION OF THE DRAWINGS

FIG. 1A is a schematic sectional view illustrating an example of a capacitor according to one exemplary embodiment of the present disclosure. FIG. 1B is a schematic sectional view illustrating an example of a capacitor according to another exemplary embodiment of the present disclosure.

FIG. 2A is a schematic sectional view illustrating a step in a method for producing a capacitor according to one exemplary embodiment of the present disclosure. FIG. 2B is a schematic sectional view illustrating a step in the method for producing a capacitor following the production method in FIG. 2A.

FIG. 3A is a schematic sectional view illustrating a step in the method for producing a capacitor according to one exemplary embodiment of the present disclosure. FIG. 3B is a schematic sectional view illustrating a step in the method for producing a capacitor following the production method in FIG. 3A. FIG. 3C is a schematic sectional view illustrating a step in the method for producing a capacitor following the production method in FIG. 3B. FIG. 3D is a schematic sectional view illustrating a step in the method for producing a capacitor following the production method in FIG. 3C.

FIG. 4 is a schematic sectional view illustrating a step in the method for producing a capacitor according to one exemplary embodiment of the present disclosure.

FIG. 5 is a schematic sectional view illustrating a step in the method for producing a capacitor according to one exemplary embodiment of the present disclosure.

FIG. 6 is a schematic sectional view illustrating an evaluation circuit including a capacitor according to one exemplary embodiment of the present disclosure.

FIG. 7A is a schematic sectional view illustrating a capacitor according to a modified example of the present disclosure. FIG. 7B is a schematic sectional view illustrating a stacked film included in the capacitor according to the modified example of the present disclosure.

FIG. 8 is a graph illustrating a relationship between the capacitance and the measurement frequency of a capacitor according to one exemplary embodiment of the present disclosure.

FIG. 9 is a graph illustrating a relationship between the capacitance and the measurement frequency of a capacitor according to another exemplary embodiment of the present disclosure.

FIG. 10 is a graph illustrating a relationship between the capacitance and the measurement frequency of a capacitor according to another exemplary embodiment of the present disclosure.

### DESCRIPTION OF EMBODIMENT

An object of the present disclosure is to provide a capacitor capable of suppressing a change in capacitance associated with a frequency change while increasing the capacitance.

### (1) Overview

The background leading up to capacitor 1 of the present disclosure will be described.

There has been known stacked structure including two electrodes and a stacked film in which an insulating layer containing an insulator material such as HfO₂ and a semiconductor layer containing a semiconductor material such as ZnO are alternately stacked between the two electrodes. The capacitance of this stacked structure is increased because of the stacked film in which the insulating layer and the semiconductor layer are alternately stacked as described above.

According to the examination by the inventors of the present invention, with respect to the stacked structure in which the insulating layer and the semiconductor layer are stacked as described above, there is a problem that it is difficult to suppress a change in capacitance associated with a frequency change while increasing the capacitance.

Thus, the inventors of the present invention have intensively studied to obtain a stacked structure capable of suppressing a change in capacitance associated with a frequency change while increasing the capacitance, and as a result, have reached the present disclosure.

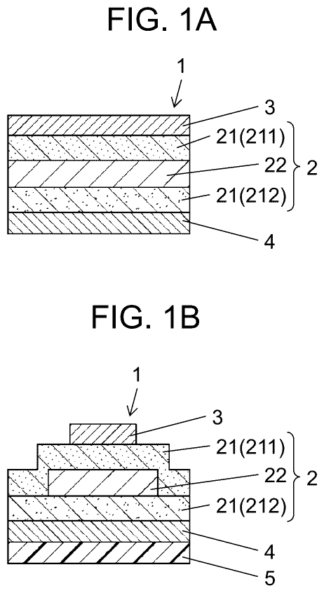

An exemplary embodiment and a modified example are described with reference to FIGS. 1A to 10. However, the following exemplary embodiment and modified example are only some of the various exemplary embodiments of the present disclosure. The exemplary embodiment and the modified example can be variously changed according to the design and the like as long as an object of the present disclosure can be achieved. It is also possible to appropriately combine the configurations of the modified example. The drawings referred to below are all schematic views, and the dimensional ratios of the configuration elements in the drawings do not necessarily reflect the actual dimensional ratios.

### (2) Exemplary Embodiment

### (2.1) Overview

First, an overview of capacitor 1 will be described with reference to FIG. 1A. As illustrated in FIG. 1A, capacitor 1 includes anode 3 and cathode 4 as electrodes, and stacked film 2 between anode 3 and cathode 4. That is, capacitor 1 includes anode 3, stacked film 2, and cathode 4, and they are stacked in this order.

Stacked film 2 includes insulating layer 21. More specifically, stacked film 2 includes first insulating layer 211 and second insulating layer 212. In other words, in stacked film 2, insulating layer 21 in contact with anode 3 is first insulating layer 211. Insulating layer 21 in contact with cathode 4 is second insulating layer 212. Since capacitor 1 includes stacked film 2 in which insulating layers 21 are stacked in this manner, the capacitance of the capacitor can be increased.

Stacked film 2 includes first insulating layer 211 in contact with anode 3, conductor layer 22, and second insulating layer 212 in contact with cathode 4, and these layers are stacked in this order. That is, conductor layer 22 is interposed between first insulating layer 211 and second insulating layer 212. Since conductor layer 22 is interposed between first insulating layer 211 and second insulating layer 212 as described above, conductor layer 22 is not in direct contact with anode 3 or cathode 4. That is, conductor layer 22 is electrically insulated from both anode 3 and cathode 4. In other words, conductor layer 22 is in a so-called electrically floating state. In the present disclosure, “in an electrically floating state” means that an object is not grounded and is electrically insulated from other members.

Then, in the present exemplary embodiment, since stacked film 2 includes conductor layer 22, an increased capacitance can be secured. That is, since stacked film 2 includes conductor layer 22, the capacitance of capacitor 1 at a time when an AC voltage is applied may be unlikely to change with a frequency change. Thus, when capacitor 1 is connected to a DC power source and installed in a circuit, an AC component (voltage noise) generated from the DC power source is removed, and thus the voltage supplied from the power source can be stabilized. In other words, capacitor 1 is suitably used as a bypass capacitor to be installed in a circuit to remove voltage noise. The application of capacitor 1 is not limited only to the bypass capacitor. Capacitor 1 can be applied to various applications.

### (2.2) Details

Details of capacitor 1 will be described.

### (Anode and Cathode)

As described above, capacitor 1 includes anode 3 and cathode 4 as electrodes. That is, when capacitor 1 is installed in a circuit, anode 3 of capacitor 1 is used to be electrically connected to the positive electrode of the power source, and cathode 4 is used to be electrically connected to the negative electrode of the power source or ground potential 7.

For example, capacitor 1 may have a terminal for external connection so as to be connectable to each of the positive electrode and the negative electrode of the power source. Such a terminal for external connection is preferably installed on each of anode 3 and cathode 4. In such a case, capacitor 1 can be installed in a circuit such that the terminal for external connection installed on anode 3 is connected to the positive electrode of the power source, and the terminal for external connection installed on cathode 4 is connected to the negative electrode of the power source.

Further, it is preferable that the two electrodes included in capacitor 1 are distinguished so that which one of the two electrodes is anode 3 or cathode 4 can be determined. A method for distinguishing between anode 3 and cathode 4 is not particularly limited. For example, anode 3 and cathode 4 are distinguished from each other by providing a marking indicating the distinction between anode 3 and cathode 4 to capacitor 1, making the shape of anode 3 different from the shape of cathode 4, or defining the positional relationship between anode 3 and cathode 4 in capacitor 1.

At least one of anode 3 and cathode 4 contains, for example, at least one selected from the group consisting of Ti, Pt, Al, Ni, TiN, Ta, TaN, Au, and the like. In this case, the capacitance of capacitor 1 can be increased. Further, at least one of anode 3 and cathode 4 preferably contains at least one of Ti, Pt, and Al. In this case, the capacitance of capacitor 1 can be further increased.

At least one of anode 3 and cathode 4 can be produced by, for example, an electron beam evaporation method. In this case, each of the thickness of anode 3 and the thickness of cathode 4 is easily adjusted as appropriate. In capacitor 1, at least one of the thickness of anode 3 and the thickness of cathode 4 is, for example, from 0.01 μm to and 1 mm inclusive.

At least one of anode 3 and cathode 4 may be, for example, a metal foil. The surface of the metal foil may be roughened. As a result, the surface area of the metal foil can be increased, and the area of stacked film 2 in contact with the metal foil can also be increased, and as a result, the capacitance of the capacitor 1 tends to be increased. A roughening method is not particularly limited, and for example, an etching method can be employed. Further, at least one of anode 3 and cathode 4 may be a porous body. In other words, the metal contained in at least one of anode 3 and cathode 4 may be a porous metal. In this case, the capacitance of capacitor 1 can be increased.

At least one of anode 3 and cathode 4 may contain, for example, a conductive polymer. The conductive polymer contains, for example, one or more components selected from the group consisting of polypyrrole, polythiophene, polyaniline, derivatives thereof, and the like.

(Stacked film)

### <Insulating Layer>

As described above, stacked film 2 includes, as insulating layers 21, first insulating layer 211 in contact with anode 3 and second insulating layer 212 in contact with cathode 4.

At least one of first insulating layer 211 and second insulating layer 212 preferably contains a compound of at least one metal selected from the group consisting of Al, Si, Ta, Hf, and the like. More specifically, at least one of first insulating layer 211 and second insulating layer 212 preferably contains at least one selected from the group consisting of Al₂O₃, SiO₂, Ta₂O₅, HfO₂, and the like, which are oxides of the above-described metals. In this case, the capacitance of capacitor 1 can be increased. It is more preferable that at least one of first insulating layer 211 and second insulating layer 212 contains Al₂O₃. In this case, the capacitance of capacitor 1 can be further increased. Further, it is particularly preferable that both first insulating layer 211 and second insulating layer 212 contain Al₂O₃. In this case, the capacitance of capacitor 1 can be particularly increased. Only one metal compound may be contained in at least one of first insulating layer 211 and second insulating layer 212, or two or more metal compounds may be contained.

A metal having an oxide film may be produced by oxidizing the surface of the metal that can be anode 3 by an anodic oxidation method, and the oxide film portion may be used as first insulating layer 211. In this case, a portion not oxidized can be anode 3. A metal having an oxide film may be produced by oxidizing the surface of the metal that can be cathode 4 by an anodic oxidation method, and the oxide film portion may be used as second insulating layer 212. In this case, a portion not oxidized can be cathode 4.

The thickness of insulating layer 21 is preferably adjusted to fall in a specific range. Specifically, at least one of the thickness of first insulating layer 211 and the thickness of second insulating layer 212 preferably ranges from 5.0 nm to 20.0 nm, inclusive. In this case, with respect to capacitor 1, a change in capacitance associated with a frequency change can be suppressed while generation of a leakage current is suppressed. When both the thickness of first insulating layer 211 and the thickness of second insulating layer 212 range from 5.0 nm to 20.0 nm, inclusive, with respect to capacitor 1, a change in capacitance associated with a frequency change can be further suppressed while generation of a leakage current is further suppressed.

When at least one of the thickness of first insulating layer 211 and the thickness of second insulating layer 212 ranges from 5.0 nm to 20.0 nm, inclusive, the capacitance of capacitor 1 tends to increase while the cutoff frequency of capacitor 1 increases. When both the thickness of first insulating layer 211 and the thickness of second insulating layer 212 range from 5.0 nm to 20.0 nm, inclusive, the capacitance of capacitor 1 tends to further increase while the cutoff frequency of capacitor 1 further increases. In the present disclosure, the cutoff frequency means a frequency at a time when the capacitance has decreased to 95% with respect to the capacitance at 100 Hz.

Further, in the present exemplary embodiment, the thickness of first insulating layer 211 and the thickness of second insulating layer 212 may be the same value or different values. That is, each of the thickness of first insulating layer 211 and the thickness of second insulating layer 212 is preferably adjusted as appropriate such that the capacitance of capacitor 1 can be increased or a change in capacitance associated with a change in frequency can be suppressed with respect to capacitor 1.

Each of the thickness of first insulating layer 211 and the thickness of second insulating layer 212 can be measured using a transmission electron microscope (TEM). More specifically, as the thickness of first insulating layer 211 and the thickness of second insulating layer 212, thicknesses at five or more points freely selected are measured using TEM, and an average value of the measured values at the five or more points can be used.

### <Conductor Layer>

The stacked film 2 includes conductor layer 22 as described above.

Conductor layer 22 can be made of, for example, a conductive material. Examples of the conductive material include metals such as transition metals and alloys of these metals. More specifically, conductor layer 22 preferably contains at least one of Ti, Pt, Au, and Al. In this case, with respect to capacitor 1, a change in capacitance associated with a frequency change can be further suppressed.

Further, in the present exemplary embodiment, since stacked film 2 includes conductor layer 22, the cutoff frequency of capacitor 1 tends to increase. More specifically, capacitor 1 including conductor layer 22 tends to have a cutoff frequency higher than that of a capacitor including a semiconductor layer made of a semiconductor material instead of conductor layer 22. As a result, with respect to capacitor 1, a change in capacitance associated with a frequency change tends to be suppressed. In addition, capacitor 1 including conductor layer 22 containing at least one of Ti, Pt, Au, and Al tends to have a higher cutoff frequency.

The thickness of conductor layer 22 is preferably adjusted to fall in a specific numerical range. Specifically, the thickness of conductor layer 22 preferably ranges from 20.0 nm to 100.0 nm, inclusive. In this case, with respect to capacitor 1, a change in capacitance associated with a frequency change can be further suppressed. In addition, when conductor layer 22 has an appropriate thickness of more than or equal to 20.0 nm, a continuous and uniform film can be obtained.

The thickness of conductor layer 22 can be measured by the same method as in the case of first insulating layer 211 and second insulating layer 212.

As described above, conductor layer 22 is interposed between first insulating layer 211 and second insulating layer 212. For example, as illustrated in FIG. 1A, when the surface of conductor layer 22 in contact with first insulating layer 211 is an upper surface, and the surface of conductor layer 22 in contact with second insulating layer 212 is a lower surface, conductor layer 22 may be disposed such that the upper surface and the lower surface of conductor layer 22 are in contact with first insulating layer 211 and second insulating layer 212, respectively, in capacitor 1, and a surface (side surface) different from the upper surface or the lower surface of conductor layer 22 does not have to be covered with first insulating layer 211 or second insulating layer 212. In addition, as illustrated in FIG. 1B, conductor layer 22 may be disposed such that the lower surface thereof is in contact with second insulating layer 212 and a region other than the lower surface is covered with first insulating layer 211.

As described above, conductor layer 22 is in an electrically floating state. More specifically, conductor layer 22 is not in direct contact with anode 3 or cathode 4, and is not connected to, for example, a member such as a terminal for external connection included in capacitor 1. In addition, when capacitor 1 is installed in a circuit, that is, used as an element of a circuit, conductor layer 22 is not electrically connected to other elements in the circuit, and is not grounded.

### (2.3) Production Method

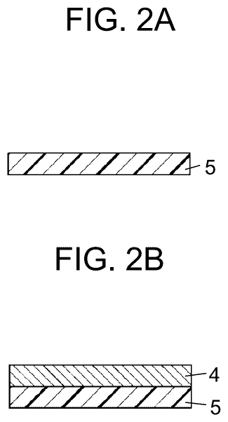

A method for producing capacitor 1 will be described with reference to FIGS. 2A to 2B, 3A to 3D, 4, and 5. The following method for producing capacitor 1 is an example of a method for producing capacitor 1. That is, as a method for producing capacitor 1, an appropriate production method can be employed depending on the use application and the purpose of use of capacitor 1.

In the method for producing capacitor 1, cathode 4, stacked film 2, and anode 3 are sequentially produced on substrate 5 (see FIGS. 2A to 5). In other words, the method for producing capacitor 1 includes a cathode production step, a stacked film production step, an anode production step, and an etching step. Hereinafter, these steps will be described in detail.

### <Cathode Production Step>

In the cathode production step, first, substrate 5 is prepared (see FIG. 2A). As substrate 5, for example, a Si substrate or the like is used. Subsequently, substrate 5 is cleaned with an etching agent or the like to remove stains such as organic substances attached to the surface of substrate 5. As the etching agent, buffered hydrofluoric acid (a mixed solution of hydrofluoric acid and ammonium fluoride) is suitably used.

Then, cathode 4 is produced on cleaned substrate 5 (see FIG. 2B). Examples of the method for producing cathode 4 include a method for producing cathode 4 containing an appropriate metal by continuously forming a thin film containing a vapor deposition material by an electron beam vapor deposition method. The electron beam vapor deposition method is a method of irradiating a vapor deposition material with an electron beam in vacuum, heating and evaporating the vapor deposition material, and depositing the vapor deposition material on substrate 5 to produce a thin film. In the present disclosure, the vapor deposition material used to produce cathode 4 contains, for example, one selected from the group consisting of Ti, Pt, Al, Ni, TiN, Ta, TaN, Au, and the like.

### <Stacked Film Production Step>

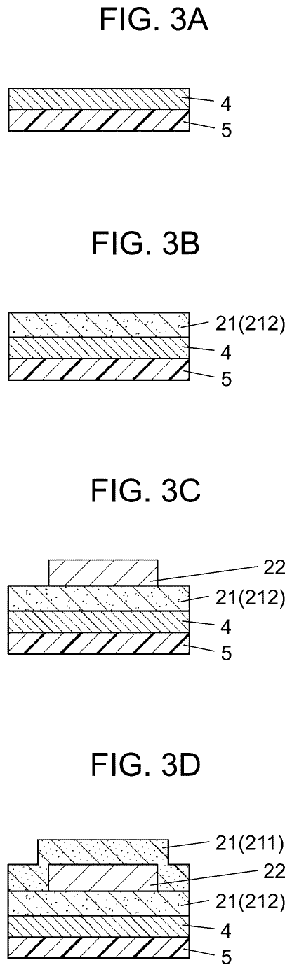

First, second insulating layer 212 is produced on cathode 4 (see FIGS. 3A and 3B). Subsequently, conductor layer 22 is produced on second insulating layer 212 produced on cathode 4 (see FIG. 3C). Then, first insulating layer 211 is produced on conductor layer 22 (see FIG. 3D). Stacked film 2 is produced through such a procedure. When first insulating layer 211 is produced on conductor layer 22, as described above, first insulating layer 211 may be produced to cover the entire surface of conductor layer 22 (see FIG. 3D), or may be produced such that only the upper surface of conductor layer 22 is covered with first insulating layer 211 and the side surface is not covered with first insulating layer 211.

Examples of a method for producing first insulating layer 211 and second insulating layer 212 include a method by an atomic layer deposition method (ALD method). The atomic layer deposition method is a film forming method in which a layer containing an oxide of metal is produced on a surface of an object by alternately supplying a raw material gas containing metal and an oxidant to a reaction chamber in which the object is disposed by using an atomic layer deposition device (ALD device). Since a self-stopping action functions in the atomic layer deposition method, metal is deposited on the surface of the object in units of atomic layers. Thus, the adsorption of the metal raw material through the supply of the raw material gas, the removal of the surplus raw material through the exhaust (purge) of the raw material gas, the oxidation of the metal raw material through the supply of the oxidant, and the exhaust (purge) of the oxidant are set as one cycle, and the thickness of the layer to be produced can be controlled by the number of cycles. As the raw material gas, a gas obtained by gasifying an organometallic compound is preferably used. It is preferable that the reaction chamber is set under a reduced pressure atmosphere before film formation, and stacked film 2 is produced in the reaction chamber under a reduced pressure atmosphere. Specifically, the pressure in the reaction chamber is reduced to, for example, less than or equal to 26.7 Pa.

For film formation, for example, during film formation, an inert gas is caused to flow through the reaction chamber at a constant flow rate. As the inert gas, for example, N₂, Ar, or the like is used. The flow rate of the inert gas is, for example, 4.39×10⁻¹ Pa·m³/s.

The time for supplying the raw material gas for causing the metal raw material to be adsorbed is, for example, from 0.12 seconds to 0.14 seconds inclusive. The exhaust (purge) of the excess raw material gas is performed by flowing an inert gas. As the inert gas, N₂, Ar, or the like is used. The flow rate of the inert gas at the time of exhausting (purging) the excess raw material gas is, for example, 4.39×10⁻¹ Pa·m³/s as described above. The time for exhausting (purging) the excess raw material gas is, for example, from 10 seconds to 20 seconds inclusive.

The time for supplying the oxidant to oxidize the adsorbed metal raw material is, for example, from 0.06 seconds to 0.07 seconds inclusive. As the oxidant, for example, H₂O, O₂ plasma, O₃, or the like can be used, and among these, H₂O is preferably used. The excess oxidant is exhausted (purged) by flowing an inert gas. As the inert gas, N₂, Ar, or the like is used. The flow rate of the inert gas at the time of exhausting (purging) the excess oxidant can be the same as the flow rate of the inert gas at the time of exhausting (purging) the excess raw material gas. The time for exhausting (purging) the excess oxidant is, for example, from 10 seconds to 20 seconds inclusive.

When a layer is formed by the atomic layer deposition method, the temperature at the time of film formation can be, for example, 150 °C. As a result, a chemical reaction generated when first insulating layer 211 and second insulating layer 212 are produced is easily adjusted, and first insulating layer 211 and second insulating layer 212 can be stably formed.

The raw material gas used for producing first insulating layer 211 and second insulating layer 212 contains, for example, a compound of at least one metal selected from the group consisting of Al, Si, Ta, Hf, and the like. In other words, the raw material gas used in producing first insulating layer 211 and second insulating layer 212 contains, for example, at least one selected from the group consisting of an organometallic compound containing Al, an organometallic compound containing Si, an organometallic compound containing Ta, an organometallic compound containing Hf, and the like.

Examples of the organometallic compound containing Al include trimethylaluminum (TMA, (CH₃)₃Al). When an organometallic compound containing Al is used, each of first insulating layer 211 and second insulating layer 212 containing Al₂O₃ whose thickness is adjusted can be produced.

Examples of the organometallic compound containing Si include tris(dimethylamino)silane (3DMAS, HSi[N(CH₃)₂]₃). When an organometallic compound containing Si is used, each of first insulating layer 211 and second insulating layer 212 containing SiO₂ whose thickness is adjusted can be produced.

Examples of the organometallic compound containing Ta include (t-butylimide)tris(ethylmethylamino)tantalum (V) (TBTEMT, (CH₃)₃CNTa[N(C₂H₅)CH₃]₃). When an organometallic compound containing Ta is used, each of first insulating layer 211 and second insulating layer 212 containing Ta₂O₅ whose thickness is adjusted can be produced.

Examples of the organometallic compound containing Hf include tetrakis(ethylmethylamino)hafnium (TEMAH, Hf[N(C₂H₅)CH₃]₄). When an organometallic compound containing Hf is used, each of first insulating layer 211 and second insulating layer 212 containing HfO₂ whose thickness is adjusted can be produced.

As a method for producing conductor layer 22, for example, a method using an electron beam evaporation method can be employed as in the method of producing cathode 4. More specifically, conductor layer 22 containing an appropriate metal can be produced by continuously forming a thin film containing a vapor deposition material such as metal by an electron beam vapor deposition method. The deposition material used to produce conductor layer 22 contains, for example, at least one selected from the group consisting of Ti, Pt, Au, and Al. When an electron beam evaporation method is employed to produce conductor layer 22, the thickness of produced conductor layer 22 can be adjusted to an appropriate value.

### <Anode Production Step>

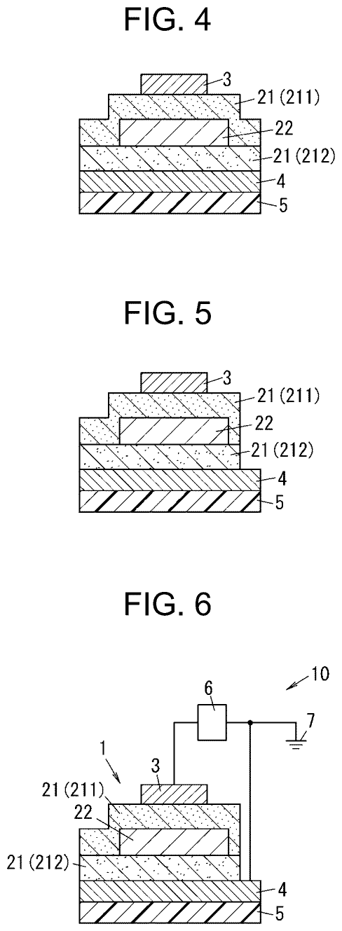

Anode 3 is produced on first insulating layer 211 (see FIG. 4). To produce anode 3, the same method as the method for producing cathode 4 can be applied, and for example, anode 3 containing an appropriate metal can be produced by an electron beam evaporation method. Anode 3 can be produced using the same vapor deposition material used when cathode 4 is produced.

Anode 3 is produced, for example, in such a manner as to partially cover a surface of first insulating layer 211 on anode 3 side (see FIG. 4). As a result, a portion of stacked film 2 not sandwiched between anode 3 and cathode 4 can be easily removed in the etching step described later.

### <Etching Step>

A part of stacked film 2 is removed by etching (see FIG. 5). This can expose a part of cathode 4, and as a result, the exposed portion of cathode 4 can be electrically connected to the negative electrode of the power source or ground potential 7. In FIG. 5, a part of cathode 4 is exposed by removing a part of first insulating layer 211 and a part of second insulating layer 212. However, for example, etching may be performed by using anode 3 as a mask to remove a part of first insulating layer 211, a part of conductor layer 22, and a part of second insulating layer 212. Further, to protect anode 3 and the interface between anode 3 and first insulating layer 211 from damage during etching, etching may be performed after anode 3 and the peripheral portion thereof are protected with a resist or the like.

Capacitor 1 is produced according to the above procedure. The production of capacitor 1 is not limited to the procedure of sequentially producing cathode 4, stacked film 2, and anode 3 on substrate 5 as described above, but a method of sequentially producing anode 3, stacked film 2, and cathode 4 on substrate 5 may be employed.

### (2.4) Performance

The performance of capacitor 1 will be described.

As described above, capacitor 1 includes stacked film 2 including conductor layer 22 between first insulating layer 211 and second insulating layer 212. With this configuration, capacitor 1 can realize a capacitance higher than theoretical capacitance C represented by the following Formula (1). Capacitor 1 can further realize a capacitance higher than theoretical capacitance C represented by the following Formula (1) when the measurement frequency is less than or equal to 1 MHz, can further realize a capacitance higher than theoretical capacitance C represented by the following Formula (1) when the measurement frequency is less than or equal to 10,000 Hz, and can realize a capacitance higher than theoretical capacitance C represented by the following Formula (1) particularly when the measurement frequency is 100 Hz.

$$\begin{matrix}[ Mathematical Formula 1 ] & \\ \frac{1}{C} = \frac{1}{C 1} + \frac{1}{C 2} & ( 1 )\end{matrix}$$

In the above Formula (1), C1 is the capacitance between anode 3 and cathode 4 at a time when only first insulating layer 211 is interposed between anode 3 and cathode 4. C2 is the capacitance between anode 3 and cathode 4 at a time when only second insulating layer 212 is interposed between anode 3 and cathode 4.

Each of value of C1 and value of C2 in above Formula (1) is calculated based on the area of the portion where anode 3 and cathode 4 face each other. More specifically, the area of the portion where anode 3 and cathode 4 face each other is the area of the electrode in the portion of the surface of anode 3 on cathode 4 side facing cathode 4, and is also the area of the electrode in the portion of the surface of cathode 4 on anode 3 side facing anode 3.

The capacitance of capacitor 1 tends to improve as the measurement frequency decreases, and specifically, the capacitance of capacitor 1 tends to improve at a measurement frequency of less than or equal to 1 Mz, tends to further improve at a measurement frequency of less than or equal to 10,000 Hz, and tends to further improve at a measurement frequency of less than or equal to 1,000 Hz. In capacitor 1, the capacitance tends to improve particularly when the measurement frequency is 100 Hz, and the capacitance higher than theoretical capacitance C represented by the above Formula (1) can be particularly realized.

Further, in capacitor 1 of the present disclosure, an effect of suppressing a change in capacitance associated with a frequency change is remarkably observed in a specific measurement frequency range. More specifically, since stacked film 2 includes conductor layer 22 in capacitor 1, an effect of suppressing a change in capacitance associated with a frequency change in a measurement frequency range of from 100 Hz to 1 MHz inclusive is remarkably observed. As a result, with respect to capacitor 1, the performance of removing the voltage noise generated in the measurement frequency range of from 100 Hz to 1 MHz inclusive can be enhanced. In addition, since stacked film 2 includes conductor layer 22, capacitor 1 tends to suppress a change in capacitance associated with a frequency change in a measurement frequency range of from 100 Hz to 1 MHz inclusive as compared with capacitor 1 having stacked film 2 including a semiconductor layer containing a semiconductor material such as ZnO instead of conductor layer 22. Further, with respect to capacitor 1, the effect of suppressing the change in capacitance is more remarkably observed in the range of the measurement frequency of from 1,000 Hz to 1 MHz inclusive, the effect of suppressing the change in capacitance is further remarkably observed in the range of the measurement frequency of from 10,000 Hz to 1 MHz inclusive, and the effect of suppressing the change in capacitance is particularly remarkably observed at the measurement frequency of 1 MHz.

With respect to capacitor 1, the capacitance between anode 3 and cathode 4 at a measurement frequency of 100 Hz to 1 MHz is a measured value obtained by using impedance analyzer 6 (product name: Impedance analyzer 4294A, distributor: Keysight Technologies, Inc.). More specifically, evaluation circuit 10 (see FIG. 6) including capacitor 1 and impedance analyzer 6 is produced, a voltage is applied between anode 3 and cathode 4 with an AC voltage of 500 mV, and the capacitance for each frequency can be checked from the measured value of the capacitance obtained when the measurement frequency is set to 100 Hz to 1 MHz. Evaluation circuit 10 is produced such that impedance analyzer 6 is connected to anode 3 and cathode 4 of capacitor 1, and cathode 4 is connected to ground potential 7.

The cutoff frequency of capacitor 1 can also be measured using evaluation circuit 10 including capacitor 1 and impedance analyzer 6.

### (3) Modified Example

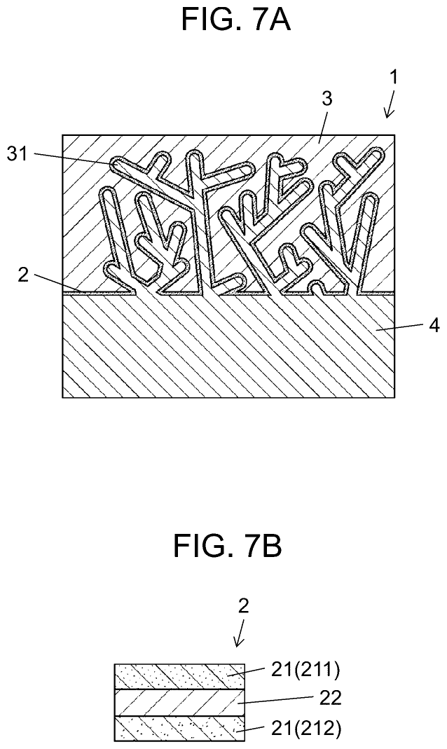

A modified example of the capacitor 1 will be described with reference to FIGS. 7A and 7B. The modified example is an example of a variation in which the configuration of the exemplary embodiment is partially changed, added, deleted, or the like. In the modified example, the same reference numerals are given to the same configurations as those of capacitor 1 of the exemplary embodiment, and the description thereof will be omitted.

In the modified example, anode 3 is a porous body having pores 31, and a part of cathode 4 has entered pores 31 of anode 3 (see FIG. 7A). Stacked film 2 (see FIG. 7B) is interposed between the inner surface of pores 31 and the portion of cathode 4 in pores 31. Since cathode 4 has entered pores 31, the facing area between anode 3 and cathode 4 may increase. As a result, the capacitance of capacitor 1 can be increased. It is also possible to employ a mode in which cathode 4 is a porous body having pores 31, and a part of anode 3 has entered cathode 4.

In the modified example, an appropriate material can be applied to the electrode of capacitor 1. For example, anode 3 can contains Al, and cathode 4 can contain a conductive polymer. In other words, capacitor 1 includes anode 3 containing Al, stacked film 2 in which insulating layer 21 and conductor layer 22 are stacked, and cathode 4 containing a conductive polymer in this order. In this case, in capacitor 1, the conductive polymer can be applied as cathode 4 while having high capacitance because of the application of Al of the porous body as anode 3. Thus, capacitor 1 can be applied as a conductive polymer aluminum electrolytic capacitor. In this case, stacked film 2 can be a dielectric film that is located between anode 3 and cathode 4 and covers cathode 4. Stacked film 2 included in capacitor 1 preferably includes an oxide film. In other words, it is preferable that at least one of first insulating layer 211 and second insulating layer 212 contains Al₂O₃.

In addition, also when anode 3 is a porous body, stacked film 2 having a three-layer structure in which first insulating layer 211, conductor layer 22, and second insulating layer 212 are stacked can be produced by producing first insulating layer 211 and second insulating layer 212 by an atomic layer deposition method and producing conductor layer 22 by an electron beam evaporation method. Anode 3 may have an anodic oxide film on the surface thereof. In other words, first insulating layer 211 may be produced by oxidizing a part of anode 3 by an anodic oxidation method. Then, stacked film 2 may be produced by producing conductor layer 22 on first insulating layer 211 which is the anodic oxide film by an electron beam evaporation method, and subsequently producing second insulating layer 212 by an atomic layer deposition method.

Cathode 4 may include both a conductive polymer and a metal-containing electrode, or it does not have to include a conductive polymer. In other words, in the modified example, capacitor 1 may have a configuration in which cathode 4 does not contain a conductive polymer, but a layer containing a conductive polymer is stacked between second insulating layer 212 and cathode 4 containing a metal such as Al or Ag.

In the modified example, with respect to capacitor 1, one of anode 3 and cathode 4 may contain Al, and the other of the anode and the cathode may contain a conductive polymer. That is, in capacitor 1, not only the configuration in which anode 3 contains Al, and cathode 4 contains the conductive polymer but also the configuration in which, for example, cathode 4 contains Al, and anode 3 contains the conductive polymer can be employed. In this case, in capacitor 1, the conductive polymer can be applied as anode 3 while having high capacitance because of the application of Al of the porous body as cathode 4.

Further, in the modified example, capacitor 1 may have a configuration in which both anode 3 and cathode 4 contain Al. Specifically, capacitor 1 can employ a configuration in which anode 3 containing Al, stacked film 2 as a dielectric film, a layer containing a conductive polymer, and cathode 4 containing Al are stacked in this order. In this case, stacked film 2 as a dielectric film preferably includes an oxide film containing Al₂O₃. In other words, at least one of first insulating layer 211 and second insulating layer 212 included in stacked film 2 preferably contains Al₂O₃. Capacitor 1 having such a configuration can have high capacitance.

### EXAMPLES

### 1. Capacitor Evaluation 1

### 1.1 Method for Producing Evaluation Circuit

According to the following procedure, capacitors 1 of Examples 1 to 2 and Comparative Example 1 were produced, and evaluation circuits 10 including these capacitors 1 were produced (see FIG. 6).

### <Production of Capacitor>

Capacitor 1 was produced by the following method.

First, substrate 5 (material Si) was prepared, and substrate 5 was cleaned with buffered hydrofluoric acid. Cathode 4 containing Ti was produced on cleaned substrate 5 by an electron beam evaporation method.

Then, substrate 5 on which cathode 4 was stacked was cleaned with ultrasonic waves while being immersed in an organic solvent such as acetone or isopropyl alcohol.

Subsequently, supply of a gas of trimethylaluminum, exhaust of the gas of trimethylaluminum, supply of an H₂O gas, and exhaust of the H₂O gas were set as one cycle, and this cycle was sequentially repeated on cathode 4 by an atomic layer deposition method to produce second insulating layer 212 containing Al₂O₃.

Next, for capacitor 1 of Examples 1 to 2, a layer containing Ti (conductor layer 22) was produced on second insulating layer 212 by an electron beam evaporation method. Then, first insulating layer 211 containing Al₂O₃ was produced according to the same procedure as the procedure for producing second insulating layer 212 on conductor layer 22.

For capacitor 1 of Comparative Example 1, a layer containing ZnO (semiconductor layer) was produced on second insulating layer 212 by the same procedure as the procedure for producing second insulating layer 212 except that the gas of trimethylaluminum was replaced with a gas of diethylzinc. Then, first insulating layer 211 containing Al₂O₃ was produced on the semiconductor layer in the same procedure as the procedure for producing second insulating layer 212. That is, in capacitor 1 of Comparative Example 1, a semiconductor layer is produced instead of conductor layer 22, as compared with capacitor 1 of Examples 1 and 2.

Subsequently, for each of Examples 1 and 2 and Comparative Example 1, anode 3 containing Ti was produced on first insulating layer 211 by an electron beam evaporation method. Then, stacked film 2 on the surface of cathode 4 on anode 3 side at a portion not facing anode 3 was removed by etching to expose a part of cathode 4, whereby capacitor 1 was produced.

In the production of capacitors 1 of Examples 1 and 2 and Comparative Example 1, the thicknesses of anode 3, cathode 4, first insulating layer 211, second insulating layer 212, conductor layer 22, and the semiconductor layer were each adjusted to have the values described in Table 1.

As described above, first insulating layer 211 and second insulating layer 212 included in the capacitors 1 of Examples 1 and 2 and Comparative Example 1, and the semiconductor layer included in capacitor 1 of Comparative Example 1 were produced by an atomic layer deposition method using an atomic layer deposition device (product name: Fiji F200, distributor: manufactured by CambridgeNanoTech). The film formation conditions per cycle when first insulating layer 211, second insulating layer 212, and the semiconductor layer were produced by the atomic layer deposition method were as follows.

### <Insulating Layer>

Film formation temperature: 150 °C
Time for supplying raw material gas for adsorption of metal raw material: 0.12 seconds
Time for exhausting (purging) excess raw material gas: 10 seconds
Time for supplying oxidant for oxidizing metal raw material: 0.06 seconds
Time for exhausting (purging) oxidant to remove oxidant: 10 seconds

### <Semiconductor Layer>

Film formation temperature: 150 °C
Time for supplying raw material gas for adsorption of metal raw material: 0.14 seconds
Time for exhausting (purging) excess raw material gas: 20 seconds
Time for supplying oxidant for oxidizing metal raw material: 0.07 seconds
Time for exhausting (purging) oxidant to remove oxidant: 20 seconds

At the time of film formation, Ar was used as an inert gas, and the inert gas was caused to flow at a constant flow rate. The flow rate of the inert gas was 4.39×10⁻¹ Pa·m³/s. That is, the supply of the oxidant for oxidizing the metal raw material and the exhaust (purge) of the oxidant for removing the oxidant are performed at the above-described flow rate. The number of cycles at the time of film formation in the atomic layer deposition was adjusted such that the thickness of first insulating layer 211, the thickness of second insulating layer 212, and the thickness of the semiconductor layer had values described in Table 1.

### <Production of Evaluation Circuit Used for Measurement of Capacitance and Cutoff Frequency>

For capacitors 1 of Examples 1 and 2 and Comparative Example 1, anode 3 and a part of exposed cathode 4 were connected to impedance analyzer 6, and cathode 4 was further connected to ground potential 7, whereby evaluation circuit 10 was produced (see FIG. 6). As impedance analyzer 6, impedance analyzer 4294A (manufactured by Keysight Technologies, Inc.) was used.

### 1.2 Evaluation Results

### <Capacitance>

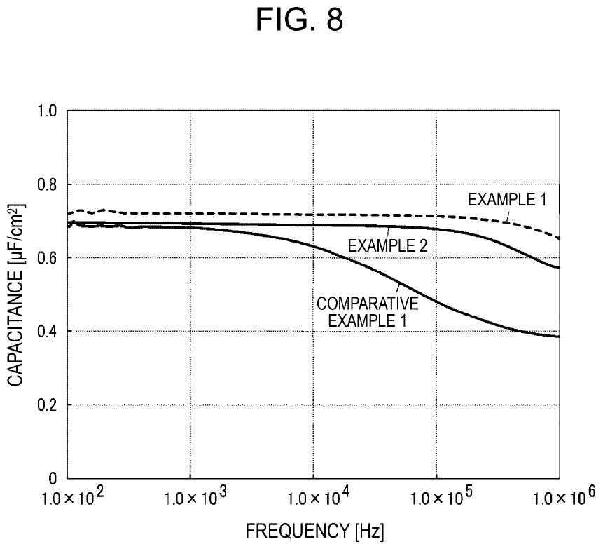

For evaluation circuits 10 including capacitors 1 of Examples 1 and 2 and Comparative Example 1, the capacitance of capacitors 1 of Examples 1 and 2 and Comparative Example 1 were measured by applying a voltage between anode 3 and cathode 4 as an AC voltage of 500 mV in a frequency band of 100 Hz to 1 MHz. For capacitors 1 of Examples 1 and 2 and Comparative Example 1, the relationship between the measurement frequency and the capacitance is illustrated in FIG. 8. The measurement results of the capacitance obtained at the measurement frequencies of 100 Hz and 1 MHz are described in Table 1. The theoretical capacitances of capacitors 1 of Examples 1 and 2 and Comparative Example 1 are values calculated according to Formula (1) described in “(2.4) Performance”.

### <Cutoff Frequency>

In accordance with the method described in “<Capacitance>”, the capacitance was measured for each frequency in a frequency band of 100 Hz to 1 MHz. Then, the frequency at which the capacitance decreased to 95% with respect to the capacitance at 100 Hz was taken as the cutoff frequency. The measurement results obtained for each of capacitors 1 of Examples 1 and 2 and Comparative Example 1 are described in Table 1.

TABLE 1

| | | | | | | | Comparative |
|---|---|---|---|---|---|---|---|
| | | | | | Example | | Example |
| | | | | | 1 | 2 | 1 |
| Capacitor | Structure | | Item | Unit | — | — | — |
| | Anode | | Thickness | nm | 100 | 100 | 100 |
| | | | Material | — | Ti | Ti | Ti |
| | Stacked | First | Thickness | nm | 8.3 | 8.3 | 8.3 |
| | film | insulating | Material | — | Al₂O₃ | Al₂O₃ | Al₂O₃ |
| | | layer | | | | | |
| | | Conductor | Thickness | nm | 20 | 100 | — |
| | | layer | Material | — | Ti | Ti | — |
| | | Semiconductor | Thickness | nm | — | — | 20 |
| | | layer | Material | — | — | — | Zno |
| | | Second | Thickness | nm | 8.3 | 8.3 | 8.3 |
| | | insulating | Material | — | Al₂O₃ | Al₂O₃ | Al₂O₃ |
| | | layer | | | | | |
| | Cathode | | Thickness | nm | 100 | 100 | 100 |
| | | | Material | — | Ti | Ti | Ti |
| Evaluation | Capacitance | Capacitance | — | μF/cm² | 0.73 | 0.70 | 0.70 |
| | | (@100 Hz) | | | | | |
| | | Capacitance | — | μF/cm² | 0.65 | 0.57 | 0.38 |
| | | (@1 MHz) | | | | | |
| | | Theoretical | — | μF/cm² | 0.37 | 0.37 | 0.37 |
| | | capacitance | | | | | |

| | | | | | |
|---|---|---|---|---|---|
| Cutoff frequency | — | kHz | 410 | 220 | 3.4 |

It has been shown that capacitors 1 of Examples 1 and 2 including conductor layer 22 had a large difference between the capacitance at the measurement frequency of 100 Hz to 1 MHz and the capacitance as compared with capacitor 1 of Comparative Example 1 including a semiconductor layer instead of conductor layer 22.

It has been shown that capacitors 1 of Examples 1 and 2 including conductor layer 22 had higher capacitance at the measurement frequency of 1 MHz as compared with capacitor 1 of Comparative Example 1 including a semiconductor layer instead of conductor layer 22.

It has been shown that in capacitors 1 of Examples 1 and 2 including conductor layer 22, the difference between the capacitance at the measurement frequency of 100 Hz and the capacitance at the measurement frequency of 1 MHz was small as compared with the case of capacitor 1 of Comparative Example 1 including a semiconductor layer instead of conductor layer 22.

It has been shown that capacitors 1 of Examples 1 and 2 including conductor layer 22 had a high cutoff frequency as compared with capacitor 1 of Comparative Example 1 including a semiconductor layer instead of conductor layer 22.

### 2. Capacitor Evaluation 2

### 2.1 Method for Producing Evaluation Circuit

Capacitor 1 of Example 3, and evaluation circuit 10 (see FIG. 6) including capacitor 1 of Example 3 and impedance analyzer 6 were produced in the same procedure as the procedure for producing the capacitor of Example 2 described in “1. Capacitor evaluation 1 1.1 Method for producing evaluation circuit” except that the metal used for producing conductor layer 22 of capacitor 1 of Example 2 was changed from Ti to Pt.

### 2.2 Evaluation Results

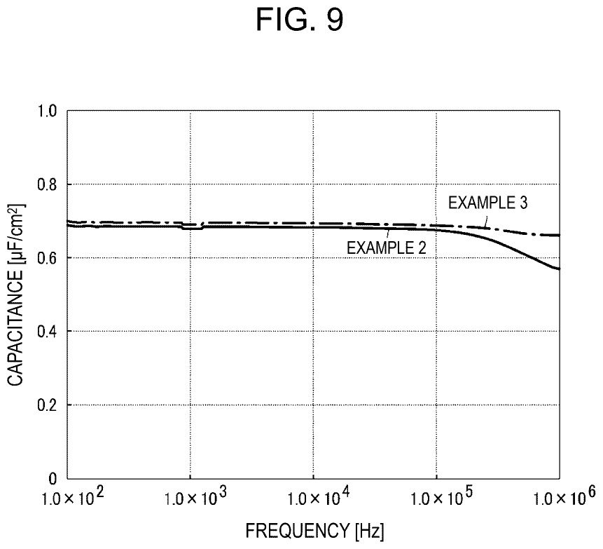

The capacitance and the cutoff frequency of capacitor 1 of Example 3 were measured according to the method described in “1. Capacitor evaluation 1 1.2 Evaluation results”. For capacitor 1 of Example 3, the relationship between the measurement frequency and the capacitance is illustrated in FIG. 9. For capacitor 1 of Example 3, the measurement results of the capacitance and the cutoff frequency obtained at the measurement frequencies of 100 Hz and 1 MHz are described in Table 2.

For comparison with Example 3, the relationship between the measurement frequency and the capacitance of capacitor 1 of Example 2 obtained in “1. Capacitor evaluation 1” is illustrated in FIG. 9, and the measurement results of the capacitance and the cutoff frequency obtained at the measured frequencies of 100 Hz and 1 MHz are described in Table 2.

TABLE 2

| | | | | | Example | |
|---|---|---|---|---|---|---|
| | | | | | 2 | 3 |
| Capacitor | Structure | | Item | Unit | — | — |
| | Anode | | Thickness | nm | 100 | 100 |
| | | | Material | — | Ti | Ti |
| | Stacked | First | Thickness | nm | 8.3 | 8.3 |
| | film | insulating | Material | — | Al₂O₃ | Al₂O₃ |
| | | layer | | | | |
| | | Conductor | Thickness | nm | 100 | 100 |
| | | layer | Material | — | Ti | Pt |
| | | Second | Thickness | nm | 8.3 | 8.3 |
| | | insulating | Material | — | Al₂O₃ | Al₂O₃ |
| | | layer | | | | |
| | Cathode | | Thickness | nm | 100 | 100 |
| | | | Material | — | Ti | Ti |
| Evaluation | Capacitance | Capacitance | — | μF/cm² | 0.70 | 0.72 |
| | | (@100 Hz) | | | | |
| | | Capacitance | — | μF/cm² | 0.57 | 0.67 |
| | | (@1 MHz) | | | | |
| | | Theoretical | — | μF/cm² | 0.37 | 0.37 |
| | | capacitance | | | | |

| | | | | |
|---|---|---|---|---|
| Cutoff frequency | — | kHz | 220 | 490 |

From the evaluation results of capacitors 1 of Examples 3 and 2, it has been shown that by changing the metal contained in conductor layer 22 from Ti to Pt, the difference between the capacitance and the theoretical capacitance at a measurement frequency of 100 Hz to 1 MHz can be increased.

In addition, from the evaluation results of capacitors 1 of Examples 3 and 2, it has been shown that even when other metals such as Pt are used in addition to Ti, capacitor 1 including conductor layer 22 can increase the difference between the capacitance and the theoretical capacitance at a measurement frequency of 100 Hz to 1 MHz and can increase the cutoff frequency, as compared with capacitor 1 of Comparative Example 1 including a semiconductor layer instead of conductor layer 22.

### 3. Capacitor Evaluation 3

### 3.1 Method for Producing Evaluation Circuit

Capacitors 1 of Examples 4 and 5, and evaluation circuits 10 (see FIG. 6) respectively including capacitors 1 of Examples 4 and 5 and impedance analyzer 6 were produced in the same procedure as the procedure for producing the capacitor of Example 2 described in “1. Capacitor evaluation 1 1.1 Method for producing evaluation circuit” except that the thickness of first insulating layer 211 and the thickness of second insulating layer 212 of the capacitor of Example 2 were changed to the numerical values described in Table 3.

### 3.2 Evaluation Results

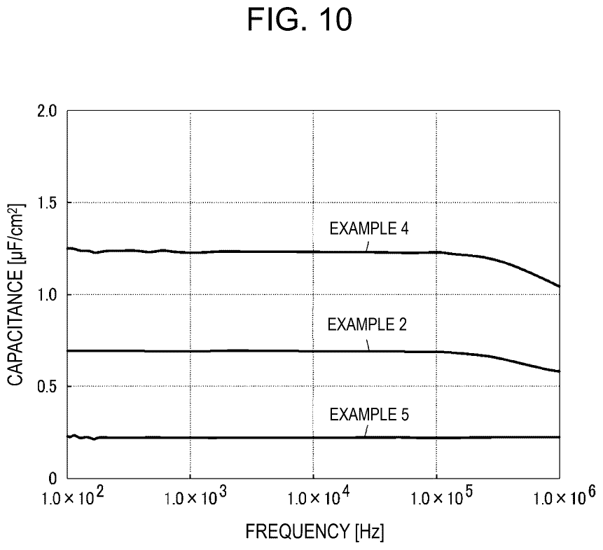

The capacitance and the cutoff frequency of capacitor 1 of Examples 4 and 5 were measured according to the method described in “1. Capacitor evaluation 1 1.2 Evaluation results”. For capacitors 1 of Examples 4 and 5, the relationship between the measurement frequency and the capacitance is shown in FIG. 10. For capacitors 1 of Examples 4 and 5, the measurement results of the capacitance and the cutoff frequency obtained at the measurement frequencies of 100 Hz and 1 MHz are described in Table 3.

For comparison with Examples 4 and 5, the relationship between the measurement frequency and the capacitance of capacitor 1 of Example 2 obtained in “1. Capacitor evaluation 1” is illustrated in FIG. 10, and the measurement results of the capacitance and the cutoff frequency obtained at the measured frequencies of 100 Hz and 1 MHz are described in Table 3.

TABLE 3

| | | | | | Example | | |
|---|---|---|---|---|---|---|---|
| | | | | | 2 | 4 | 5 |
| Capacitor | Structure | | Item | Unit | — | — | — |
| | Anode | | Thickness | nm | 100 | 100 | 100 |
| | | | Material | — | Ti | Ti | Ti |
| | Stacked | First | Thickness | nm | 8.3 | 5 | 20 |
| | film | insulating | Material | — | Al₂O₃ | Al₂O₃ | Al₂O₃ |
| | | layer | | | | | |
| | | Conductor | Thickness | nm | 100 | 100 | 100 |
| | | layer | Material | — | Ti | Ti | Ti |
| | | Second | Thickness | nm | 8.3 | 5 | 20 |
| | | insulating | Material | — | Al₂O₃ | Al₂O₃ | Al₂O₃ |
| | | layer | | | | | |
| | Cathode | | Thickness | nm | 100 | 100 | 100 |
| | | | Material | — | Ti | Ti | Ti |
| Evaluation | Capacitance | Capacitance | — | μF/cm² | 0.70 | 1.25 | 0.23 |
| | | (@100 Hz) | | | | | |
| | | Capacitance | — | μF/cm² | 0.57 | 1.04 | 0.22 |
| | | (@1 MHz) | | | | | |
| | | Theoretical | — | μF/cm² | 0.37 | 0.55 | 0.13 |
| | | capacitance | | | | | |

| | | | | | |
|---|---|---|---|---|---|
| Cutoff frequency | — | kHz | 220 | 290 | >1000 |

From the evaluation results of capacitor 1 of Examples 4 and 5 and 2, it has been shown that by reducing the thickness of first insulating layer 211 and the thickness of second insulating layer 212, the capacitance at a measurement frequency of 100 Hz to 1 MHz can be increased.

### Conclusions

As apparent from the above exemplary embodiments, the present disclosure includes the following aspects. In the following, reference marks are given in parentheses only to clarify the correspondence relationship with the exemplary embodiments.

Capacitor (1) according to a first aspect of the present disclosure includes anode (3), stacked film (2), and cathode (4) stacked in this order. Stacked film (2) includes first insulating layer (211) in contact with anode (3), conductor layer (22), and second insulating layer (212) in contact with cathode (4) stacked in this order. Conductor layer (22) is electrically insulated from both anode (3) and cathode (4).

According to the first aspect, it is possible to provide capacitor (1) capable of suppressing a change in capacitance associated with a frequency change while increasing the capacitance.

In capacitor (1) according to a second aspect of the present disclosure, in the first aspect, at least one of first insulating layer (211) and second insulating layer (212) contains Al₂O₃.

According to the second aspect, the capacitance of capacitor (1) can be further increased.

In capacitor (1) according a third aspect of the present disclosure, in the first or second aspect, at least one of a thickness of first insulating layer (211) and a thickness of second insulating layer (212) ranges from 5.0 nm to 20.0 nm, inclusive.

According to the third aspect, with respect to capacitor (1), a change in capacitance associated with a frequency change can be suppressed while the occurrence of leakage current is suppressed. In addition, the capacitance of capacitor (1) tends to increase while the value of the cutoff frequency of capacitor (1) increases.

In capacitor (1) according to a fourth aspect of the present disclosure, in any one of the first to third aspects, a capacitance between anode (3) and cathode (4) at a measurement frequency of 100 Hz is larger than a theoretical capacitance represented by Formula (1) shown below.

$$\begin{matrix}[ Mathematical Formula 2 ] & \\ \frac{1}{C} = \frac{1}{C 1} + \frac{1}{C 2} & ( 1 )\end{matrix}$$

C: a theoretical capacitance, C1: a capacitance between anode (3) and cathode (4) in a case where only first insulating layer (211) is interposed between anode (3) and cathode (4), and C2: a capacitance between anode (3) and cathode (4) in a case where only second insulating layer (212) is interposed between anode (3) and cathode (4) According to the fourth aspect, the capacitance of capacitor (1) at a measurement frequency of 100 Hz can be particularly increased.

In capacitor (1) according to a fifth aspect of the present disclosure, in any one of the first to fourth aspects, conductor layer (22) contains at least one of Ti, Pt, Au, and Al.

According to the fifth aspect, with respect to capacitor (1), a change in capacitance associated with a frequency change can be further suppressed. In addition, capacitor (1) tends to have a higher cutoff frequency.

In capacitor (1) according to a sixth aspect of the present disclosure, in any one of the first to fifth aspects, a thickness of conductor layer (22) ranges from 20.0 nm to 100.0 nm, inclusive.

According to the sixth aspect, with respect to capacitor (1), a change in capacitance associated with a frequency change can be further suppressed.

In capacitor (1) according to a seventh aspect of the present disclosure, in any one of the first to sixth aspects, at least one of anode (3) and cathode (4) contains at least one of Ti, Pt, and Al.

According to the seventh aspect, the capacitance of capacitor (1) can be increased.

In capacitor (1) according to an eighth aspect of the present disclosure, in any one of the first to seventh aspects, one of anode (3) and cathode (4) contains Al, and the other of the anode (3) and the cathode (4) contains a conductive polymer.

According to the eighth aspect, capacitor (1) can be applied to a conductive polymer aluminum electrolytic capacitor.

### REFERENCE MARKS IN THE DRAWINGS

1: capacitor
2: stacked film
3: anode
4: cathode
21: insulating layer
211: first insulating layer
212: second insulating layer
22: conductor layer
31: pore

1. A capacitor comprising an anode, a stacked film, and a cathode stacked in this order,
wherein the stacked film includes a first insulating layer in contact with the anode, a conductor layer, and a second insulating layer in contact with the cathode stacked in this order, and
the conductor layer is electrically insulated from both the anode and the cathode.

2. The capacitor according to claim 1, wherein at least one of the first insulating layer and the second insulating layer contains Al₂O₃.

3. The capacitor according to claim 1, wherein at least one of a thickness of the first insulating layer and a thickness of the second insulating layer ranges from 5.0 nm to 20.0 nm, inclusive.

4. The capacitor according to claim 1, wherein
a capacitance between the anode and the cathode at a measurement frequency of 100 Hz is larger than a theoretical capacitance represented by formula shown below
$$\frac{1}{C} - \frac{1}{C 1} + \frac{1}{C 2}$$
where is a theoretical capacitance
C1 is a capacitance between the anode and the cathode in a case where only the first insulating layer is interposed between the anode and the cathode, and
C2 is a capacitance between the anode and the cathode in a case where only the second insulating layer is interposed between the anode and the cathode

5. The capacitor according to claim 1, wherein the conductor layer contains at least one selected from the group consisting of Ti, Pt, Au, and Al.

6. The capacitor according to claim 1, wherein a thickness of the conductor layer ranges from 20.0 nm to 100.0 nm, inclusive.

7. The capacitor according to claim 1, wherein at least one selected from the group consisting of the anode and the cathode contains at least one of Ti, Pt, and Al.

8. The capacitor according to claim 1, wherein one of the anode and the cathode contains Al, and the other of the anode and the cathode contains a conductive polymer.
